(19) United States
(12) Patent Application Publication
(10) Pub. No.: US 2006/0039025 A1
(43) Pub. Date: Feb. 23, 2006

(54) Network-accessible document bulletin board enabling on-demand printing in a networked office environment

(75) Inventors: Marc J. Krolczyk, Spencerport, NY (US); Andrew T. Martin, Honeoye Falls, NY (US)

Correspondence Address: ORTIZ & LOPEZ, PLLC;Patent Attorneys, P.O. Box 4484, Albuquerque, NM, 87196-4484, US

(73) Assignee: Xerox Corporation

(21) Appl. No.: 10/922,311

(22) Filed: Aug. 19, 2004

(51) Int. Cl. G06F 3/12; G06F 15/00

(52) U.S. Cl. 358/1.15

(57) ABSTRACT

A network-accessible document bulletin board enables user access to on-demand printing in a networked office environment. Users upload a document or document pointer to a print server manager associated with a networked printers. A user interface accessible over a data network associated with the office environment enables the user to access print controls and identifying information about the document. The user locates and prints the document through commands entered at the user interface.

### FIELD OF THE INVENTION

The present invention is generally related to document printing over networked office environments. The present invention is also generally related to printer server managers and printer servers. More particularly, the present invention is related to a network-accessible document bulletin board that enables on-demand document upload, location and printing in a networked office environment.

### BACKGROUND

The advent of local area network and networked printing has made it possible for members of an enterprise to share printing resources and share data files electronically. It is now a simple matter to select a printing resource from a list of many printers that might be available throughout a work environment to print documents from a user's workstation. Preparing multiple sets of documents for participants expected to attend a meeting can be expeditiously carried out using larger networked printing resources, rather than a small printer that may be attached to the user's workstation.

No matter what printing resource is used, pre-printing several sets of multi-page hand-outs for meeting can often lead to unused documents that eventually end up in a trash can or document recycling bin, which can be an expensive, wasteful method of disposing unused meeting materials. Users are left little choice but to print extra copies in anticipation of meeting conference attendee requirements, despite the sophistication of networked printers and high speed data networks.

Over-printing classified documents is ultimately very costly and very risky for a corporation or government entity, yet under printing documents can lead to loss of time and productivity for all parties involved in a meeting or conference where additional documents must be copied.

Accordingly, there is a need to better facilitate document printing in a networked office environment that will overcome current logistical limitations. There is a need for print-on-demand features available to users over a data network (e.g., LAN, WLAN) in an office or campus environment.

### SUMMARY

The present inventors have come to realize that meeting handouts (or any other document) could be printed as needed if current printer server user interfaces have a print-on-demand reprint feature and a printing facility/equipment located in an easily accessible location near a planned meeting for users to print-out extra documents for additional meeting attendees.

In accordance with a feature of the present invention, a network-accessible document bulletin board is provided that enables on-demand document location and printing in a networked office environment.

In accordance with a feature of the present invention, users access a document bulletin board presented in the form of a user interface (UI) and upload a document or document pointer to a print server manager associated with a networked printers.

In accordance with a feature of the present invention, a user interface accessible over a data network associated with the office environment enables the user to access print controls and identifying information about the document.

In accordance with a feature of the present invention, a user can locate and print document through commands entered at the user interface.

In accordance with another feature of the present invention, the user interface is not only accessible from the user's desktop.

In accordance with another feature of the present invention, the user interface is accessible from user-authorized network connections, including wireless and wired connections, throughout a networked work environment.

In accordance with another feature of the present invention, a user can locate and print a document through the user interface to any printer available and accessible to the user throughout the networked work environment.

The present invention provides on-demand printing in a networked office environment. The present invention is implemented using a user interface (UI) in association with printer server managers and printer servers operating in the networked environment. Users use the UI to upload a document or document pointer to a print server manager associated with a networked printers. A user interface accessible over a data network associated with the office environment enables the user to access print controls and identifying information about the document. The user locates and prints the document through commands entered at the user interface.

### SUMMARY FO THE DRAWINGS

FIG. 1 illustrates a screen shot of a document print manager user interface provided in the form of a webpage that is accessible over a data network.

FIG. 2 illustrates a flow diagram of steps for carrying out a method of the present invention.

FIG. 3 illustrates a printer user interface in accordance with a feature of the present invention.

FIG. 4 illustrates a system architecture including components necessary to carry out the unique features of the present invention.

### DETAILED DESCRIPTION OF PREFERRED EMBODIMENTS

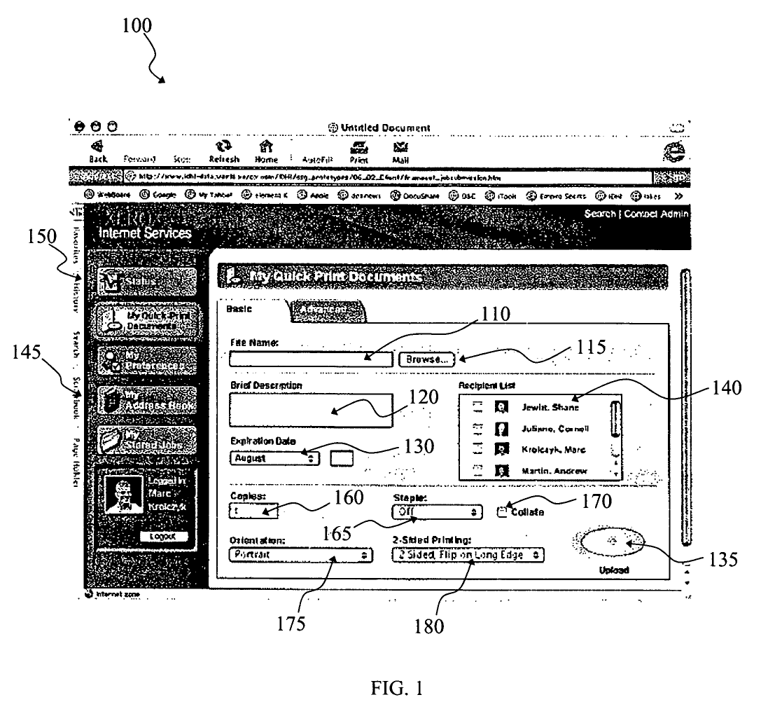

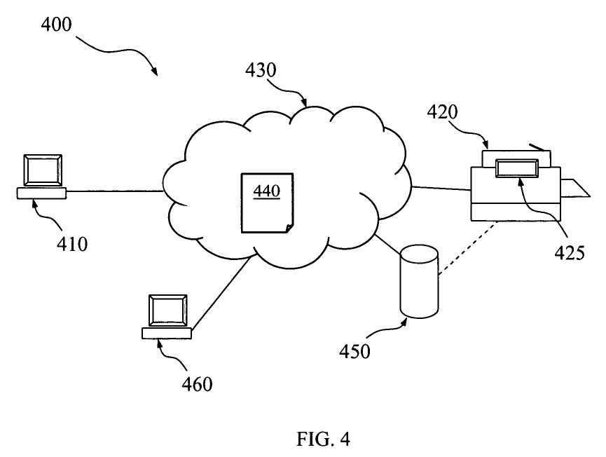

Referring to FIG. 1, a user interface (UI) 100 generated by a document print manager is illustrated. The document print manager is a software application running in a server in communication with the network. The UI 100 is displayed on the client workstation that allows a user to interact with the document print manager. The UI 100 is provided in the form of a client user interface dialog that is accessible over a data network. The document print manager UI 100 as shown is not meant to operate as a limitation of the features of the present invention, but is illustrated how a user interface can be laid out to provide the unique features of the invention described herein. The UI 100 and document print manager 440 shown in FIG. 4 provide an embodiment of the document bulletin board.

The document print manager 100 can be provided to a user that is logged into a data network such as a local area network, or a wide local area network associated with a large enterprise and campus environments. The document print manager 100 shown in FIG. 1 identifies the user by name and picture 190, although such a feature is optional. The document print manager 100 will preferably enable a user to identify documents by “file name” 110 that will be made available for future retrieval (e.g., location) and printing.

The document print manager 100 is shown referring to available documents identified through the service as “My Quick Print documents,” although other titles are appropriate. Documents that will be selected for access and management using the document print manager 100 can be located in a user's workstation memory locations (e.g., hard drive), removable memory (e.g., removable disk memory) or in the user's dedicated server memory location (assigned folders), using a “browse” button 115, which is a feature well-known to Windows™ users. A user can also provide a “brief description” of selected documents using a text field 120. Documents can remain listed in the UI 100 for a defined term by setting an “expiration date” in a date field 130.

Documents identified to the document print manager 100 can be uploaded and stored in a print server (not shown) associated with the document print manager 100 using the “upload” key 135. In the alternative, a link to the document's storage location can be listed in the user's document print manager.

Another feature shown in the document print manager UI 100 is a “recipient list” 140. The recipient list 140 enables a user to distribute documents identified in the document print manager to recipients listed in the recipient list 140. The recipient list can be populated with associates using the address book 145 feature. Address books are well known to Windows™ users. (The recipient list is actually more of an access list in that the individuals included in the list have access to the associated document(s) so that when they walk up to a networked print device and authenticate themselves the documents that they have access to would be displayed on the bulletin board.)

Yet another feature shown in the document print manager 100 is a status button 150, where a user can check on the status of document: printing, expiration, distribution, identifying information.

Other features shown in the document print manager UI 100 are associated with document printing. A user can select the number of copies to print 160, can select a staple feature 165, collate documents 170, select a particular orientation for documents 175, and select 2-sided printing 180. It should be appreciated that more preferences can be provided in the document print manager 100 than are listed in FIG. 1.

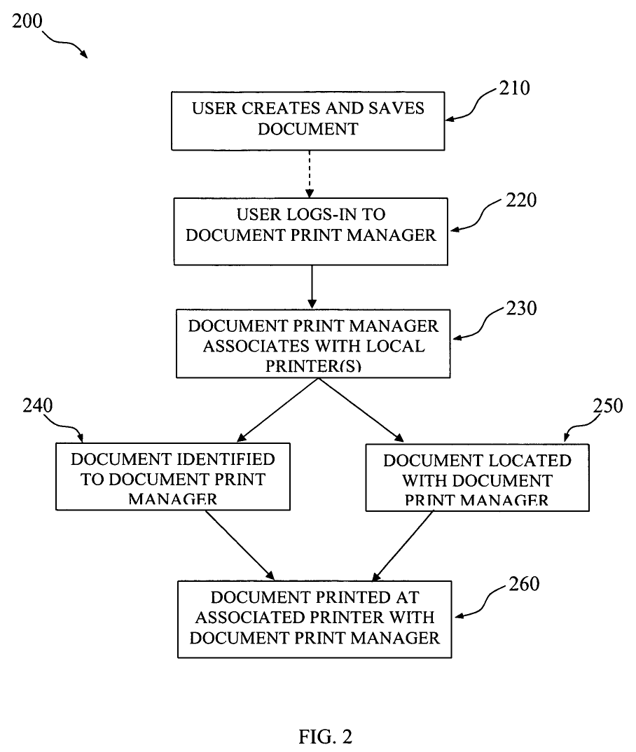

Referring to FIG. 2, a flowchart 200 of a process of using the invention is illustrated. As shown in block 210, a document is created and saved using a standard computer application such as Microsoft Word™ or PowerPoint™. At some point after the document is created, it is identified to the document print manager as shown in block 240. The document can be identified at the document print manager at which time the document can be uploaded and stored in a print server or a link to the document can be saved in the document print manager UI. If the document is selected for printing, it is processed, a job ticket is normally sent along with the document to the print server where it is saved (e.g., queued) until it is printed.

At some point after the document is stored and identified to the document print manager, it can be accessed by the user when the user opens and logs into document printer manager UI as shown in block 220. Such access may actually occur after an initial print out has been achieved for the document. In such case, the user will likely want to now re-print a document. After the user logs into, the document printer manager becomes associated with a printer located nearest the user as shown in block 240. Association is based on the user's location upon logging into the document print manager UI. Once logged into the document print manager, the user can locate a document as shown in block 250. The user can next choose to print the document to the printer associated with the document print manager upon log-in by the user, as show in block 260. The intent is that the user will use the client to define the documents to be posted on the bulletin board accessible by clients through UI 100, potentially identify the recipient printers, and define the individuals who, when they log in at the printer, will be presented with the document(s) on their bulletin board. Printing from a client application is obviously not novel.

It should be appreciated that the user can log into the document print manager using a workstation, wireless device or printer. For example, in a conference room, the user may log into the document print manager using a laptop having a wireless connection. The nearest printer will be identified based on the wireless access point the user become connected to. The user can also log into the document print manager directly at the printer using the printer user interface, which will now be described in more detail.

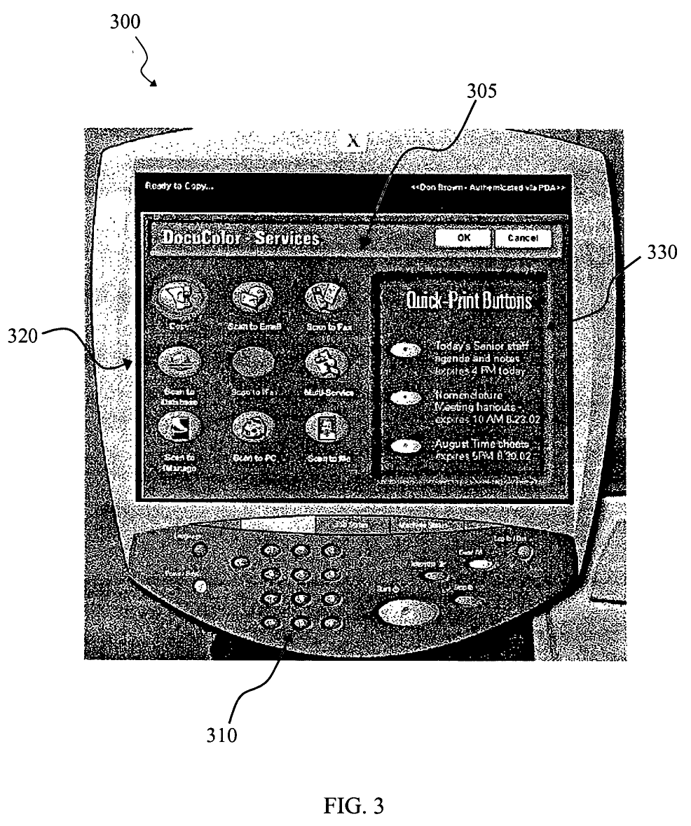

Referring to FIG. 3, a printer user interface 300 is shown. A printer UI 300 is typically provided in the form of a panel located with a printer. The panel is normally operated with a combination of hard buttons 310 and soft buttons 320 through a touch sensitive screen 305. The printer UI 300 shown in FIG. 3 includes “quick-print button” 330. A user can log-into a network via the printer UI 300. The user can then locate a document previously printed by the user and/or identified to the print document manager by the user as described in the process of FIG. 2. The user can print copies of the selected document using the printer UI 300. The printer UI 300 and document print manager 440 shown in FIG. 4 provide another embodiment of the document bulletin board.

According to an advantage of the present invention, documents can be posted to a server associated with the user's authorized network (e.g., LAN/WAN) as opposed to a specific printing device. Therefore, when a user logs into any multifunction device (e.g., enterprise printer) on a network, all of the documents linked to the user would be displayed on a “bulletin board” shown on the UI associated with the device.

Referring to FIG. 4, a system architecture 400 with components necessary to carry out the unique features of the present invention is illustrated. As shown in the system architecture 400, a user's workstation 410 is shown connected to a data network 450. Also shown connected to the data network 450 is at least one printer 420. The printer has a user interface 425 associated with it. Also shown connected to the data network is a print server 430. The print server can also be associated with the at least one printer 420, as shown by the dotted line association. A document print manager UI 440 is shown connected in the network 450. It can be appreciated that the document print manager 440 may be provided in the form of a webpage that is accessed from the print server 430, the printer 420, or workstation 460 not directly associated with the printer 420 or print server 430. Nevertheless, what is important is that the document print manager 440 provides a format and medium (UI 100/interface 300) through which on-demand printing can be arranged, managed and carried out for a user.

1. A network-accessible document bulletin board enabling on-demand printing in a networked office environment, comprising:
providing the user access to a user interface over a data network associated with the office environment, wherein the user interface is associated with a print server manager and includes controls for storing, accessing, and printing documents and associated information; and
enabling a user to upload document information through the user interface, said document information including at least one of a document or document pointer to a print server associated with at least one networked printer.

2. The method of claim 1 wherein the print manager is located in a networked printer.

3. The method of claim 1 wherein the identifying information is uploaded with the document.

4. The method of claim 1 wherein the identifying information is uploaded with the document pointer.

5. The method of claim 4 wherein the identifying information is uploaded to a Webpage that includes user controls to enable the user to add a brief description of the document, author name, expiration date, time stamps, and access control.

6. The method of claim 5 wherein the access control includes a pass code used for access verification by the print server manager.

7. The method of claim 4 wherein the identifying information includes at least one of a brief description of the document, author name, expiration date, time stamps, and access control.

8. The method of claim 7 wherein the access control includes a pass code used for access verification by the print server manager.

9. The method of claim 1 wherein the user interface enables the user to locate and print the document through commands entered at the user interface.

10. A network-accessible document bulletin board enabling user access to on-demand printing in a networked office environment, comprising:
enabling a user to upload at least one of a document or document pointer to a print server manager associated with at least one networked printer;
providing the user access to a user interface over a data network associated with the office environment, wherein the user interface includes print controls and access to identifying information about the document; and
enabling the user to locate and print the document through commands entered at the user interface.

11. The method of claim 10 wherein the print manager is located in a networked printer.

12. The method of claim 10 wherein the identifying information is uploaded with the document.

13. The method of claim 10 wherein the identifying information is uploaded with the document pointer.

14. The method of claim 13 wherein the identifying information is uploaded to a Webpage that includes user controls to enable the user to add a brief description of the document, author name, expiration date, time stamps, and access control.

15. The method of claim 14 wherein the access control includes a pass code used for access verification by the print server manager.

16. The method of claim 13 wherein the identifying information includes at least one of a brief description of the document, author name, expiration date, time stamps, and access control.

17. The method of claim 16 wherein the access control includes a pass code used for access verification by the print server manager.
